(19) United States
(12) Patent Application Publication
(10) Pub. No.: US 2008/0107033 A1
(43) Pub. Date: May 8, 2008

(54) RADIO COMMUNICATION NETWORK CAPABLE OF RADIO COMMUNICATION WITH REDUCED OVERHEAD

(75) Inventors: Bing Zhang, Tokyo (JP); Yoichi Kado, Tokyo (JP); Masanori Nozaki, Tokyo (JP); Suhua Tang, Soraku-gun (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: National Institute of Information and Communications Technology, Tokyo (JP); OKI Electric Industry Co., Ltd., Tokyo (JP); Advanced Telecommunications Research Institute International, Soraku-gun (JP)

(21) Appl. No.: 11/933,721

(22) Filed: Nov. 1, 2007

(30) Foreign Application Priority Data
Nov. 2, 2006 (JP) 2006-298884

(51) Int. Cl. H04L 12/56; G08C 15/00

(52) U.S. Cl. 370/238

(57) ABSTRACT

In a radio communication system, a relay route is established with a plurality of wireless devices constructing an MPR set for a wireless device as a root node by transmission and reception of a Hello packet. A wireless device other than that constructing the MPR set transmits neighboring wireless device information, information of a neighboring wireless device thereof, to the wireless device as the root node via the relay route. Based on the neighboring wireless device information received via the relay route, the wireless device as the root node generates and stores topology information indicating a topology of a plurality of wireless devices constructing the radio communication system. The wireless device as the root node transmits the topology information to a plurality of wireless devices on a regular basis, or transmits to a wireless device requiring the topology information. As a result, radio communication can be performed with reduced overhead.

### BACKGROUND OF THE INVENTION

1. Field of the Invention

The present invention relates to mesh-type radio communication systems and, in particular, to a radio communication system enabling a decreased overhead.

2. Description of the Related Art

An ad hoc network is constructed autonomously and immediately with a plurality of wireless devices communicating with each other. In the ad hoc network, when two wireless devices not present in a communication area of each other are to communicate with each other, a wireless device located in an intermediate position of the two wireless devices functions as a router to relay a data packet, and thus a wide multihop network can be formed.

Dynamic routing protocols for supporting multihop communication include a table-driven protocol and an on-demand protocol. In the table-driven protocol such as FSR (Fish-eye State Routing), OLSR (Optimized Link State Routing) and TBRPF (Topology Dissemination Based on Reverse-Path Forwarding), control information regarding routes is exchanged on a regular basis to build a routing table beforehand.

In the on-demand protocol such as DSR (Dynamic Source Routing) and AODV (Ad Hoc On-Demand Distance Vector Routing), on the other hand, a route to a destination is not build until data transmission is requested.

When data is transmitted from a source to a destination in a conventional ad hoc network, a communication route is determined so as to minimize a number of hops from the source to the destination (Guangyu Pei, et al, “Fisheye state routing: a routing scheme for ad hoc wireless networks”, ICC2000. Commun., Volume 1, pp 70-74, L.A., June 2000).

A route with a small number of hops, however, is not always a route of good quality because wireless environment is unstable. It is therefore preferable to select only a stable route by a certain method. A method including introduction of a signal strength threshold and a method including monitoring of a packet loss rate are mainly known as such methods.

The method including monitoring of a packet loss rate is effective when the packet loss is continuously generated.

As the method including introduction of a signal strength threshold, a known method includes extraction of a stable route using a mean value of signal strengths (Rohit Dube, Cynthia D. Rais, Kuang-Yeh Wang, and Satish K. Tripathi, “Signal Stability based Adaptive Routing (SSA) for Ad-Hoc Mobile Networks”, IEEE Personal Communications, February 1997, pp. 36-45).

### BRIEF SUMMARY OF THE INVENTION

There is a problem of increased overhead, however, in a radio network system constructed with wireless devices which perform radio communication using link state information regarding neighboring wireless devices according to a conventional table-driven routing protocol.

The present invention was thus made to solve such a problem. An object of the present invention is to provide a radio communication system capable of radio communication with reduced overhead.

A radio communication system according to the present invention is a radio communication system enabling reduction in overhead of a control packet, which includes a first wireless device, a plurality of second wireless devices and a plurality of third wireless devices. The first wireless device is connected to a wired cable. The plurality of second wireless devices are arranged under the first wireless device and construct a relay route for relaying a packet transmitted from the first wireless device such that, when the first wireless device transmits the packet to all of the wireless devices constructing the radio communication system, each of the wireless devices transmits and receives the packet once. The plurality of third wireless devices are arranged under the first wireless device and transmit a packet to the first wireless device via any of the plurality of second wireless devices.

Preferably, each of the plurality of second wireless devices transmits first neighboring wireless device information, information of neighboring wireless device thereof to the first wireless device via the relay route. Each of the plurality of third wireless devices transmits second neighboring wireless device information, information of neighboring wireless device thereof, to the first wireless device via any of the plurality of second wireless devices. The first wireless device obtains the first and second neighboring wireless device information via the relay route and, based on the first and second neighboring wireless device information obtained, acquires topology information, information of a topology of all wireless devices constructing the radio communication system.

Preferably, the first wireless device transmits the topology information to all of the wireless devices via the relay route on a regular basis. Each of the plurality of second wireless devices receives the topology information via the relay route and, using the topology information received, performs radio communication with a destination wireless device. Each of the plurality of third wireless devices receives the topology information via one of the plurality of second wireless devices nearest therefrom and, using the topology information received, performs radio communication with a destination wireless device.

The first wireless device preferably transmits the topology information via the relay route when the wireless device thereunder needs the topology information.

Preferably, when a destination wireless device is unknown, a source wireless device included in the plurality of second wireless devices or the plurality of third wireless devices transmits a packet to be transmitted to the first wireless device via the relay route, receives the topology information from the first wireless device via the relay route, searches for an optimum route to the destination wireless device based on the topology information received, and then transmits the packet to the destination wireless device along the optimum route found.

Preferably, the radio communication system further includes a plurality of wireless devices. The plurality of wireless devices are arranged under the second wireless devices or the third wireless devices. A source wireless device included in the plurality of wireless devices generates a packet including a destination wireless device and transmits the packet to the second wireless device or the third wireless device to be accessed. The second wireless device or the third wireless device receiving the packet from the source wireless device transmits the packet to the second wireless device or the third wireless device having the destination wireless device thereunder. The second wireless device or the third wireless device having the destination wireless device thereunder receives the packet and transmits the packet to the destination wireless device.

Each of the plurality of second wireless devices and the plurality of third wireless devices is preferably an access point.

Preferably, when a destination wireless device is unknown, a source wireless device included in the plurality of second wireless devices or the plurality of third wireless devices transmits a packet to be transmitted to the first wireless device via the relay route. The first wireless device searches for an optimum route to the destination wireless device based on a destination included in the packet transmitted from the source wireless device and the topology information, and transmits the packet to the destination wireless device along the optimum route found.

The first wireless device preferably transmits the topology information via the relay route when receiving a message indicating presence of an active route from the wireless device thereunder.

In the radio communication system according to the present invention, the plurality of third wireless devices transmit a packet to the first wireless device via the relay route formed with the plurality of second wireless devices. That is, the plurality of third wireless devices transmit a packet to the first wireless device via the plurality of wireless devices forming an MPR set for the first wireless device. As a result, the plurality of third wireless devices transmit a packet to the first wireless device without searching for a route to the first wireless device.

Therefore, overhead of the radio communication system can be reduced according to the present invention.

In addition, one wireless device (=the first wireless device) acquires the topology information in the radio communication system according to the present invention.

Therefore, overhead can be reduced according to the present invention as compared to a situation wherein all wireless devices in a radio communication system acquire the topology information.

The foregoing and other objects, features, aspects and advantages of the present invention will become more apparent from the following detailed description of the present invention when taken in conjunction with the accompanying drawings

### BRIEF DESCRIPTION OF THE SEVERAL VIEWS OF THE DRAWING

FIG. 1 is a schematic diagram of a radio communication system according to an embodiment of the present invention.

FIG. 2 is a schematic block diagram of a construction of a wireless device shown in FIG. 1.

FIG. 3 is a schematic diagram of a construction of a routing table shown in FIG. 2.

FIG. 4 is a schematic diagram of a construction of a neighbor list.

FIG. 5 is a conceptual diagram of an MPR set in a case where a wireless device as a root node transmits a packet to all of wireless devices inside the radio communication system.

FIG. 6 shows a neighbor list generated by a wireless device as a root node.

FIG. 7 shows a relay route.

FIGS. 8A to 8C show other neighbor lists.

FIG. 9 is a conceptual diagram of topology information.

FIG. 10 is a conceptual diagram of a situation wherein a wireless device as a root node transmits topology information.

FIG. 11 shows a specific example of radio communication.

FIG. 12 shows a specific example of a routing table.

FIGS. 13A and 13B are other conceptual diagrams of a situation wherein a wireless device as a root node transmits topology information.

FIG. 14 is a diagram for describing another communication method in example 2.

FIG. 15 is a diagram for describing a communication method in example 3.

FIG. 16 shows address solutions in example 3.

FIG. 17 is a schematic diagram of another radio communication system according to an embodiment of the present invention.

FIGS. 18A and 18B are still other conceptual diagrams of a situation wherein a wireless device as a root node transmits topology information.

FIG. 19 is a diagram for describing a communication method in example 4.

FIG. 20 shows address solutions in the example 4.

FIG. 21 is another diagram for describing a communication method in example 4.

FIG. 22 is another diagram of the address solutions in example 4.

FIG. 23 is a diagram for describing a method for transmitting a packet to a mobile terminal belonging to another radio communication system.

FIG. 24 is still another diagram of the address solutions in example 4.

### DETAILED DESCRIPTION OF THE INVENTION

Embodiments of the present invention will now be described in detail referring to the drawings. It is to be noted that, the same or corresponding portions in the drawings are indicated with the same characters and descriptions thereof will not be repeated.

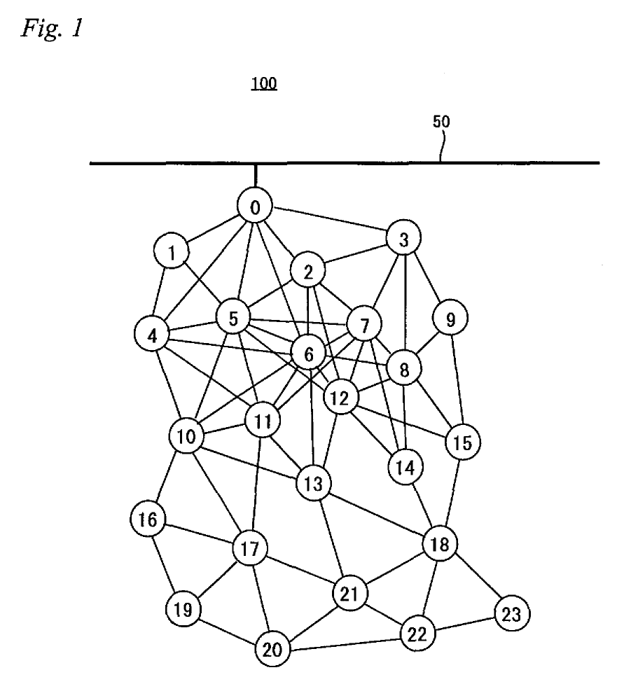

FIG. 1 is a schematic diagram of a radio communication system according to an embodiment of the present invention. Referring to FIG. 1, a radio communication system 100 according to the embodiment of the present invention includes wireless devices 0 to 23 and a wired cable 50.

Each of the wireless devices 0 to 23 is a fixed wireless device which is, for example, an access point. The wireless device 0 is a root node and the wireless devices 1 to 23 are arranged under the wireless device 0. That is, the wireless devices 1 to 23 have to communicate via the wireless device 0 to perform radio communication with a wireless device in another radio communication system.

The wireless device 0 is connected to the wired cable 50. In addition, the wireless device 0 establishes a relay route with a method as described below so that the wireless device 0 can transmit a packet to all of the wireless devices 1 to 23 with only one transmission and reception of one packet by each of the wireless devices 1 to 23. That is, the wireless device 0 establishes a relay route constructed with MPR (Multipoint Relay) terminals for the wireless device 0. Then, the wireless device 0 receives information regarding neighboring wireless devices from each of the wireless devices 1 to 23 via the relay route established as such, and generates topology information indicating a topology of whole radio communication system 100 based on the information regarding neighboring wireless devices. The wireless device 0 then transmits the topology information to the wireless devices 1 to 23 as required.

In addition to performing radio communication with the wireless devices 1 to 23, the wireless device 0 transmits a packet received via the wired cable 50 from another radio communication system to the wireless devices 1 to 23, and also transmits a packet received from the wireless devices 1 to 23 to another radio communication system via the wired cable 50.

When a relay route for the wireless device 0 to transmit a packet to all of the wireless devices 1 to 23 is established, each of the wireless devices 1 to 23 transmits neighboring wireless device information, that is, information of neighboring wireless devices thereof, to the wireless device 0 via the relay route. In addition, each of the wireless devices 1 to 23 receives topology information from the wireless device 0 and performs radio communication with each other using the topology information.

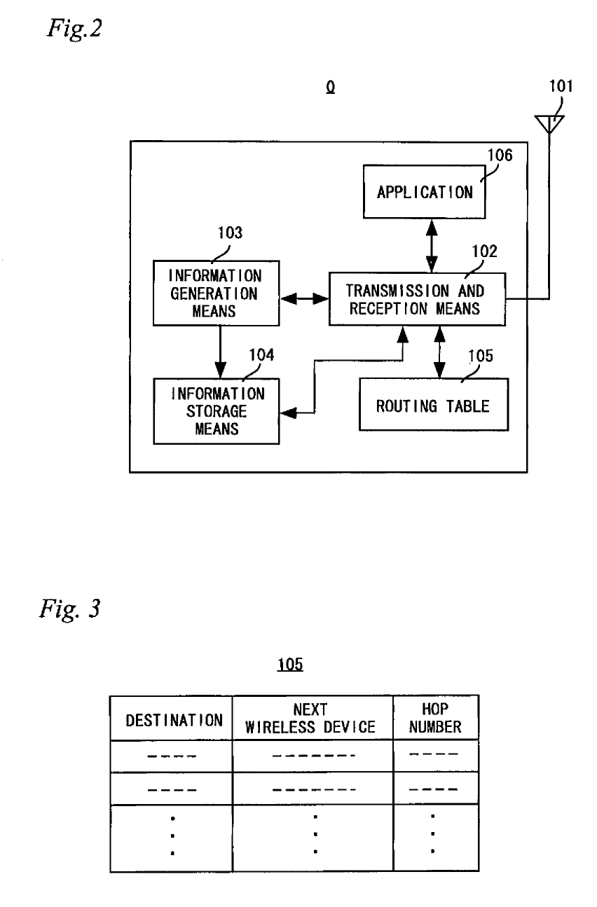

FIG. 2 is a schematic block diagram of a construction of the wireless device 0 shown in FIG. 1. Referring to FIG. 2, the wireless device 0 includes an antenna 101, transmission and reception means 102, information generation means 103, information storage means 104, a routing table 105, and an application 106.

The antenna 101 transmits a packet received from the transmission and reception means 102 to another wireless device and also outputs a packet received from another wireless device to the transmission and reception means 102.

The transmission and reception means 102 outputs a control packet PKT_CL and a neighbor list NTBL received via the antenna 101 to the information generation means 103. In addition, the transmission and reception means 102 reads the neighbor list NTBL or the topology information TPIF from the information storage means 104, and transmits the neighbor list NTBL or the topology information TPIF to another wireless device via the antenna 101. Furthermore, the transmission and reception means 102 calculates an optimum route for transmission of a packet to each destination based on the topology information TPIF read from the information storage means 104 to generate the routing table 105. Furthermore, when receiving data destined for another wireless device from the application 106, the transmission and reception means 102 enters the data in a data portion to generate a packet PKT. Then, the transmission and reception means 102 refers to the routing table 105 to determine an optimum route for transmission of the packet PKT to the destination, and transmits the packet PKT via the route determined. Furthermore, when receiving the packet PKT destined for the application 106 of the wireless device 0 via the antenna 101, the transmission and reception means 102 extracts data from the packet PKT and outputs the data to the application 106.

When the information generation means 103 receives the control packet PKT_CL received by the transmission and reception means 102 from another wireless device, the information generation means 103 generates neighbor list NTBL, a list of wireless devices neighboring to the wireless device 0, based on the control packet PKT_CL and stores the neighbor list NTBL in the information storage means 104. In addition, when receiving neighbor list NTBL received by the transmission and reception means 102 from another wireless device, the information generation means 103 generates topology information TPIF based on the neighbor list NTBL with a method described below, and stores the topology information TPIF in the information storage means 104.

The information storage means 104 stores neighbor list NTBL and topology information TPIF generated by the information generation means 103. The application 106 generates data destined for another wireless device and outputs the data to the transmission and reception means 102. In addition, the application 106 receives data thereof from the transmission and reception means 102.

FIG. 3 is a schematic diagram of a construction of the routing table 105 shown in FIG. 2. Referring to FIG. 3, the routing table 105 includes a “destination”, a “next wireless device” and a “hop number”. The “destination”, “next wireless device” and “hop number” are correlated with each other. The “destination” indicates an IP address of a destination wireless device. The “next wireless device” indicates an IP address of a wireless device which should next transmit packet PKT for transmission to the destination. The “hop number” indicates a number of hops to the destination. As an example, when radio communication is performed between the wireless device 0 and the wireless device 21 in FIG. 1 via a route of the wireless device 0—the wireless device 6—the wireless device 13—the wireless device 21, a hop number “3” is stored in the routing table 105 of the wireless device 0.

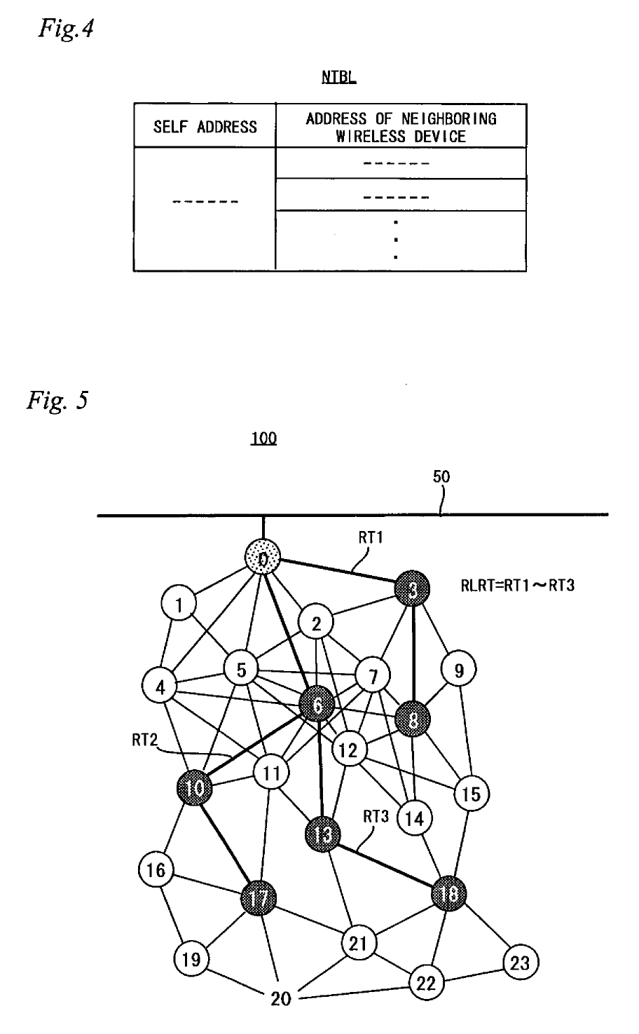

FIG. 4 is a schematic diagram of a construction of neighbor list NTBL. Referring to FIG. 4, the neighbor list NTBL includes a “self address” and an “address of neighboring wireless devices”. The “self address” is formed with an IP address of a wireless device generating the neighbor list NTBL. The “address of neighboring wireless devices” is formed with an IP address of a wireless device neighboring to the wireless device generating the neighbor list NTBL.

In the present invention, each of the wireless devices 0 to 23 generates the routing table 105 according to an OLSR protocol. Generation of the routing table 105 according to the OLSR protocol will now be described in detail. For generation of the routing table 105, each of the wireless devices 0 to 23 transmits and receives a Hello message and a TC message.

The Hello message is transmitted on a regular basis for delivery of information held by each of the wireless devices 0 to 23. Each of the wireless devices 0 to 23 can collect information regarding peripheral wireless devices by receiving the Hello message to recognize presence of wireless devices peripheral thereto.

In the OLSR protocol, each of the wireless devices 0 to 23 manages local link information. The Hello message is a message for building and transmitting the local link information. The local link information includes a “link set”, a “neighboring wireless device set”, a “2-hop neighboring wireless device set and a link set for such wireless device”, an “MPR set”, and an “MPR selector set”.

The “link set” means links to a set of wireless devices within the direct reach of radio waves (neighboring wireless devices). Each link is indicated with a valid time of a group of addresses between two wireless devices. The valid time is also used to indicate whether the link is one-way or two-way.

The “neighboring wireless device set” is formed with an address of each neighboring wireless device, willingness of the wireless device to retransmit, and the like. The “2-hop neighboring wireless device set” means a set of wireless devices neighboring to the neighboring wireless device.

The “MPR set” is a set of wireless devices each selected as MPR. For a node, its MPRs are its one hop neighbors by which all its two hop neighbors can be reached. That is, the MPRs are selected such that, when each broadcast packet PKT is transmitted to all of the wireless devices 0 to 23 of radio communication system 100, transmission of packet PKT to all of the wireless devices 0 to 23 becomes possible with only one transmission and reception of one packet PKT by each of the wireless devices 0 to 23.

The “MPR selector set” indicates a set of wireless devices each selecting the wireless device as the MPR.

Local link information is generally established as follows. As to the Hello message, each of the wireless devices 0 to 23 transmits the Hello message including the self address to neighboring wireless devices at an early stage in order to inform of presence thereof. With this step performed by all of the wireless devices 0 to 23, each of the wireless devices 0 to 23 recognizes addresses of peripheral wireless devices around itself. With this, a link set and a neighboring wireless device set are built.

The local link information built as such is transmitted again with the Hello message on a regular basis. With this step repeated, it is gradually made obvious whether each link is two-way or not, and which wireless device is present beyond the neighboring wireless devices. Each of the wireless devices 0 to 23 stores the local link information gradually built as such.

Information regarding the MPR is also transmitted with the Hello message on a regular basis, and the wireless devices 0 to 23 are informed of the information regarding the MPR. Each of the wireless devices 0 to 23 selects some of the neighboring wireless devices as the MPR set for requesting retransmission of broadcast packet PKT transmitted therefrom. Since the information regarding the MPR set is transmitted with the Hello message to the neighboring wireless devices, the wireless device receiving the Hello message manages as an “MPR selector set” a set of wireless devices selecting this wireless device as the MPR. With this, each of the wireless devices 0 to 23 can immediately recognize whether broadcast packet PKT from a certain wireless device is to be retransmitted.

FIG. 5 is a conceptual diagram of an MPR set in a case where the wireless device 0 as a root node transmits a packet to all of wireless devices inside radio communication system 100. Referring to FIG. 5 with transmission and reception of the Hello message by each of the wireless devices 0 to 23 in the steps described above, the MPR set (wireless devices 3, 6, 8, 10, 13, 17, and 18) is generated for the wireless device 0 as the root node to transmit a packet to all of wireless devices inside radio communication system 100. When the wireless device 0 transmits a packet PKT to the wireless devices 3, 6, 8, 10, 13, 17, and 18, each of the wireless devices 1, 2, 4, 5, 7, 11, 12, 14 to 16, and 19 to 23 can receive the packet PKT transmitted from the wireless device 0 via any of the wireless devices 3, 6, 8, 10, 13, 17, and 18. Therefore, the wireless devices 3, 6, 8, 10, 13, 17, and 18 construct the MPR set when the wireless device 0 transmits a packet to all of wireless devices inside radio communication system 100.

Therefore, the wireless device 0 transmits a packet PKT to all of wireless devices inside radio communication system 100 using a route RT1 formed with the wireless device 0—the wireless device 3—the wireless device 8, a route RT2 formed with the wireless device 0—the wireless device 6—the wireless device 10—the wireless device 17, and a route RT3 formed with the wireless device 0—the wireless device 6—the wireless device 13—the wireless device 18. Thus, a route formed with routes RT1-RT3 constructs a “relay route RLRT” in the present invention.

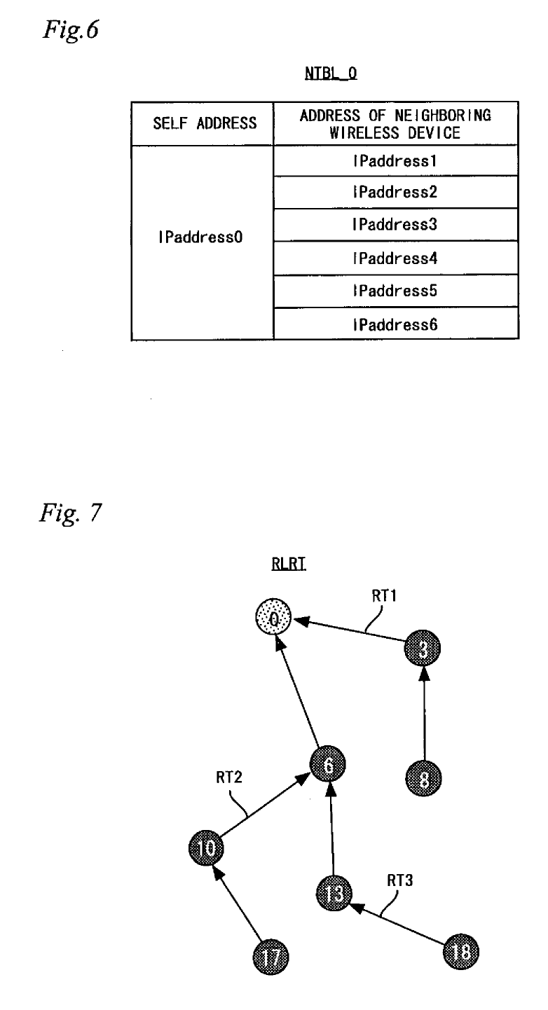

FIG. 6 shows a neighbor list generated by the wireless device 0 as the root node. Referring to FIG. 6, the transmission and reception means 102 of the wireless device 0 directly receives Hello messages [IPaddress1], [IPaddress2], [IPaddress3], [IPaddress4], [IPaddress5], and [IPaddress6] respectively from the wireless devices 1 to 6, and outputs the Hello messages [IPaddress1], [IPaddress2], [IPaddress3], [IPaddress4], [IPaddress5], and [IPaddress6] to the information generation means 103.

The information generation means 103 receives the Hello messages [IPaddress1], [IPaddress2], [IPaddress3], [IPaddress4], [IPaddress5], and [IPaddress6] from the transmission and reception means 102, and generates a neighbor list NTBL_0 in the wireless device 0 based on the Hello messages [IPaddress1], [IPaddress2], [IPaddress3], [IPaddress4], [IPaddress5], and [IPaddress6]. Then, the information generation means 103 stores the neighbor list NTBL_0 in the information storage means 104.

When the neighbor list NTBL_0 is stored in the information storage means 104, the transmission and reception means 102 reads the neighbor list NTBL_0 from the information storage means 104 and transmits the neighbor list NTBL_0 to all of the wireless devices 1 to 23 via the relay route RLRT (that is, flooding of the neighbor list NTBL_0 is performed). With this, each of the wireless devices 1 to 23 obtains information of wireless devices neighboring to the wireless device 0.

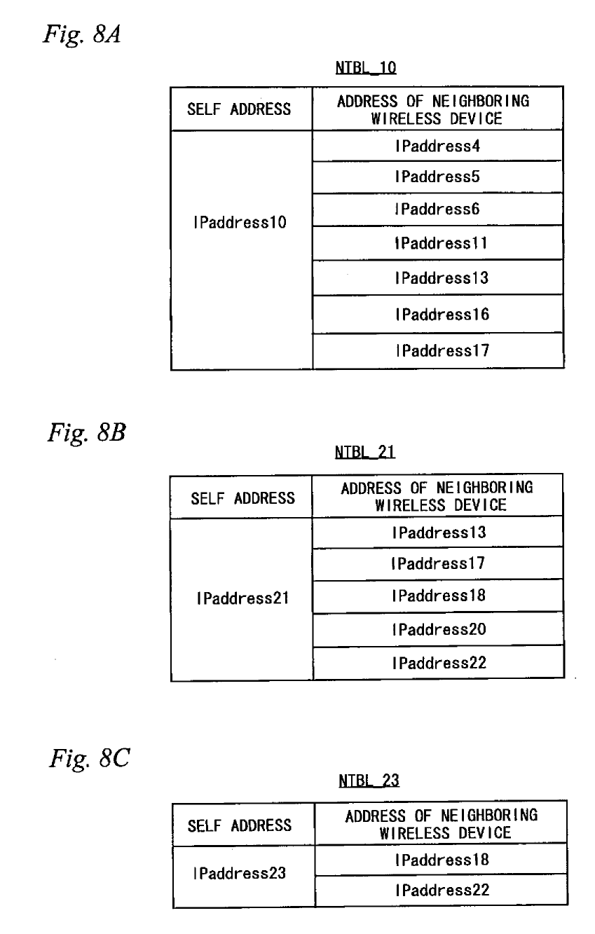

FIG. 7 shows the relay route RLRT. FIGS. 5A to 8C show other neighbor lists. FIG. 8A shows a neighbor list NTBL_10 generated in the wireless device 10, FIG. 8B shows a neighbor list NTBL_21 generated in the wireless device 21, and FIG. 8C shows a neighbor list NTBL_23 generated in the wireless device 23.

When neighbor list NTBL_0 is received from the wireless device 0 via the relay route RLRT, each of the wireless devices 1 to 23 can recognize that the relay route RLRT has established, and can also recognize the nearest MPR for the wireless device (one of wireless devices 3, 6, 8, 10, 13, 17, and 18 constructing the relay route RLRT which is nearest from that wireless device).

Then, each of the wireless devices 1 to 23 transmits a neighbor list generated therein to the wireless device 0 via the relay route RLRT by unicast. As an example, the wireless device 10 included in the relay route RLRT generates the neighbor list NTBL_10 (see FIG. 8A) and transmits the neighbor list NTBL_10 to the wireless device 6. Since the wireless device 10 has received the neighbor list NTBL_0 of the wireless device 0 from the wireless device 6, the wireless device 10 can recognize that the neighbor list NTBL_10 should be transmitted to the wireless device 6 in order to transmit the neighbor list NTBL_10 to the wireless device 0. Then, the wireless device 6 receives the neighbor list NTBL_10 from the wireless device 10 and transmits the neighbor list NTBL_10 to the wireless device 0 (see FIG. 7). As a result, the neighbor list NTBL_10 is transmitted from the wireless device 10 to the wireless device 0 via the relay route RLRT.

The wireless device 21, which is not included in the relay route RLRT, generates the neighbor list NTBL_21 (see FIG. 8B) and transmits the neighbor list NTBL_21 to the wireless device 13. Since the wireless device 21 has received neighbor list NTBL_0 of the wireless device 0 from the wireless device 13, the wireless device 21 can recognize that the neighbor list NTBL_21 should be transmitted to the wireless device 13 in order to transmit the neighbor list NTBL_21 to the wireless device 0. Then, the wireless device 13 receives the neighbor list NTBL_21 from the wireless device 21 and transmits the neighbor list NTBL_21 to the wireless device 6. The wireless device 6 receives the neighbor list NTBL_21 from the wireless device 13 and transmits the neighbor list NTBL_21 to the wireless device 0 (see FIG. 7). As a result, the neighbor list NTBL_21 is transmitted from the wireless device 21 to the wireless device 0 via the relay route RLRT.

Furthermore, the wireless device 23, which is not included in the relay route RLRT, generates the neighbor list NTBL_23 (see FIG. 8C) and transmits the neighbor list NTBL_23 to the wireless device 18. Since the wireless device 23 has received the neighbor list NTBL_0 of the wireless device 0 from the wireless device 18, the wireless device 23 can recognize that neighbor list NTBL_23 should be transmitted to the wireless device 18 in order to transmit the neighbor list NTBL_23 to the wireless device 0. Then, the wireless device 18 receives the neighbor list NTBL_23 from the wireless device 23 and transmits the neighbor list NTBL_23 to the wireless device 13. The wireless device 13 receives the neighbor list NTBL_23 from the wireless device 18 and transmits the neighbor list NTBL_23 to the wireless device 6. The wireless device 6 receives the neighbor list NTBL_23 from the wireless device 13 and transmits the neighbor list NTBL_23 to the wireless device 0 (see FIG. 7). As a result, the neighbor list NTBL_23 is transmitted from the wireless device 23 to the wireless device 0 via the relay route RLRT.

The other wireless devices 1 to 9, 11 to 20, and 22 also transmit respective neighbor lists NTBL_1-NTBL_9, NTBL_11-NTBL_20, NTBL_22 to the wireless device 0 via the relay route RLRT in the steps as described above.

As described above, the wireless device 0 receives the neighbor list from each of the wireless devices 1 to 23 via the relay route RLRT by unicast.

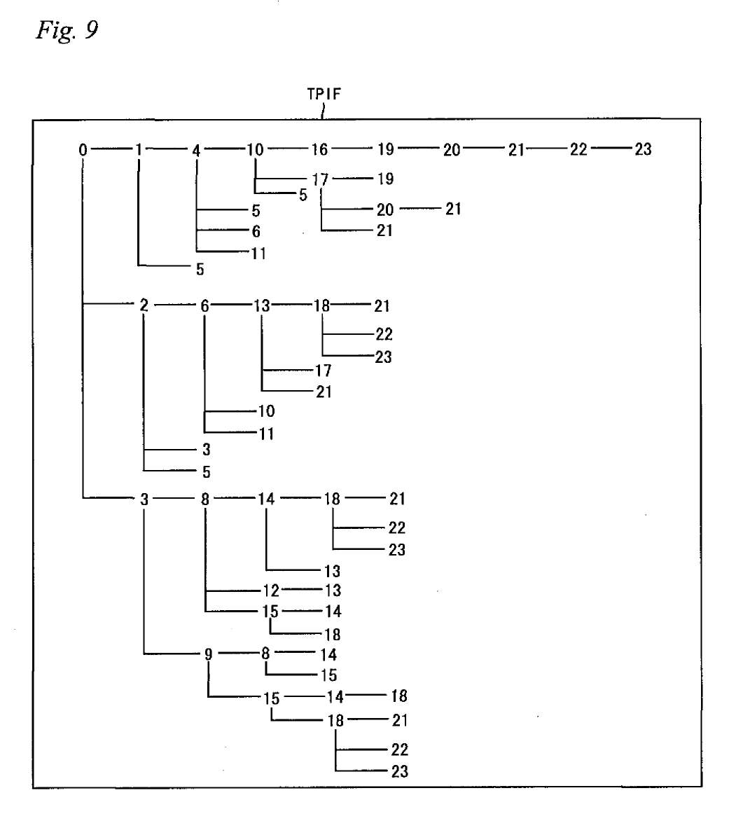

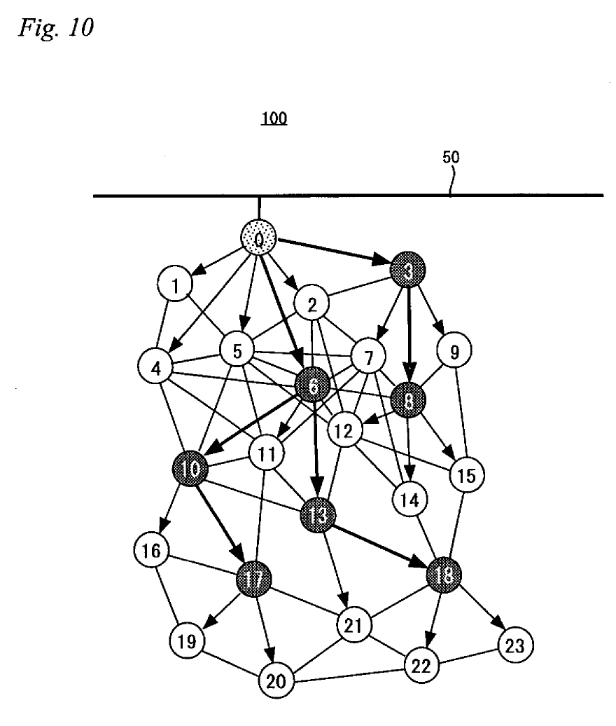

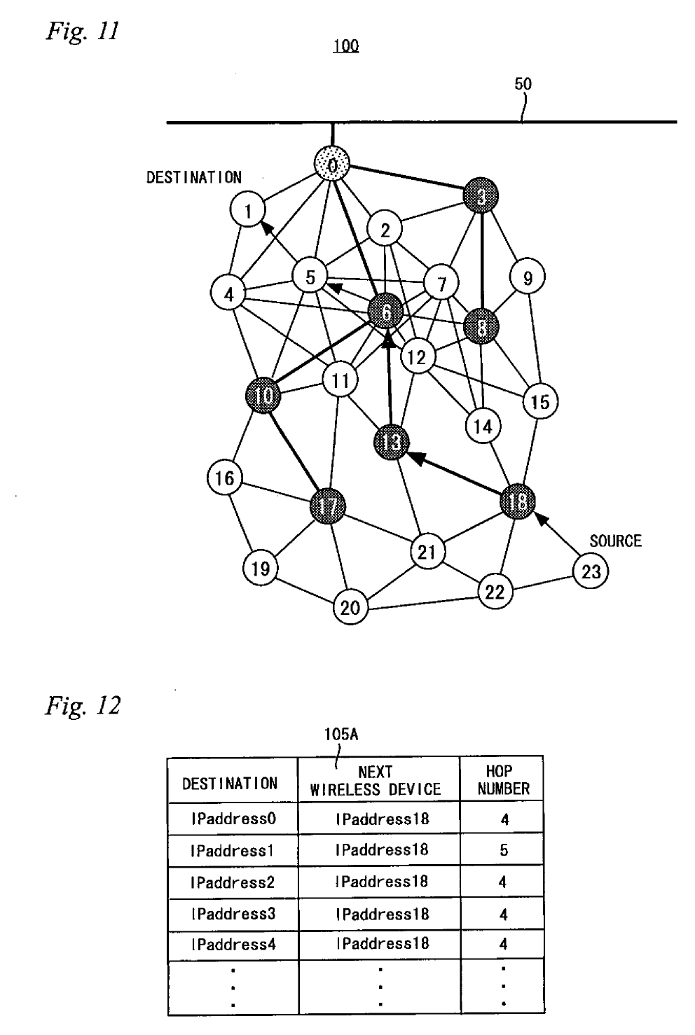

FIG. 9 is a conceptual diagram of topology information. It is to be noted that, topology information TPIF shown in FIG. 9 only indicates a partial topology of the wireless devices 0 to 23 constructing the radio communication system 100.

Referring to FIG. 9, the transmission and reception means 102 in the wireless device 0 receives the neighbor lists NTBL_1-NTBL_23 from the wireless devices 1 to 23 and generates the topology information TPIF indicating a topology of the wireless devices 0 to 23 constructing the radio communication system 100 based on the neighbor lists NTBL_1-NTBL_23.

As described above, in the radio communication system 100, the relay route RLRT formed with the MPR set for the wireless device 0 is established by transmission and reception of the Hello messages using the OSLR protocol in order for the wireless device 0 as the root node to transmit a packet to all of wireless devices inside the radio communication system 100. When the relay route RLRT is established, the wireless device 0 receives neighbor list NTBL from each of the wireless devices 1 to 23 via the relay route RLRT by unicast to generate the topology information TPIF indicating the topology of the wireless devices 0 to 23 constructing the radio communication system 100 based on the neighbor list NTBL, and stores the topology information TPIF.

As described above, in the present invention, only the wireless device 0 as the root node obtains the topology information TPIF of whole wireless devices 0 to 23 constructing the radio communication system 100 via the relay route RLRT formed with the MPR set for the wireless device 0. Therefore, overhead in obtainment of the topology information TPIF in the radio communication system 100 can be reduced.

In addition, since the topology information TPIF is managed only in the wireless device 0 in the present invention, overhead in the radio communication system 100 can be reduced.

That is, in a case where all of wireless devices constructing a radio communication system should obtain and manage topology information, the all of wireless devices obtain and manage topology information of whole wireless devices constructing the radio communication system according to the OLSR protocol. In the radio communication system 100 according to the present invention, on the other hand, only the wireless device 0 as the root node obtains and manages the topology information TPIF. Therefore overhead in the radio communication system 100 can be reduced.

In the present invention, the generated topology information TPIF is managed in the wireless device 0 as the root node and used when the wireless devices 0 to 23 perform radio communication. In this situation, the topology information TPIF is used in two manners as described in the following.

### EXAMPLE 1

FIG. 10 is a conceptual diagram of a situation wherein the wireless device 0 as a root node transmits the topology information TPIF. Referring to FIG. 10, in example 1, the wireless device 0 as the root node transmits the topology information TPIF generated by the method described above to the wireless devices 1 to 23 on a regular basis via the relay route RLRT. More specifically, the transmission and reception means 102 of the wireless device 0 reads the topology information TPIF from the information storage means 104 on a regular basis, and transmits the topology information TPIF to the wireless devices 1 to 23 via the relay route RLRT on a regular basis.

In this situation, the wireless device 0 transmits the topology information TPIF to the wireless devices 1 to 6, the wireless device 3 relays the topology information TPIF to the wireless devices 7 to 9, the wireless device 6 relays the topology information TPIF to the wireless devices 10, 1, and 13, the wireless device 8 relays the topology information TPIF to the wireless devices 12, 14, and 15, the wireless device 10 relays the topology information TPIF to the wireless devices 16 and 17, the wireless device 13 relays the topology information TPIF to the wireless devices 11 and 21, the wireless device 17 relays the topology information TPIF to the wireless devices 19 and 20, and the wireless device 18 relays the topology information TPIF to the wireless devices 22 and 23. With this, all of the wireless devices 1 to 23 receive the topology information TPIF from the wireless device 0 via the relay route RLRT.

When receiving the topology information TPIF from the wireless device 0, each of the wireless devices 1 to 23 calculates an optimum route for transmitting a packet PKT to each wireless device based on the topology information TPIF to generate the routing table 105.

FIG. 11 shows a specific example of radio communication. FIG. 12 shows a specific example of the routing table 105. Referring to FIG. 11, when the wireless device 23 (=source) transmits a packet PKT to the wireless device 1 (=destination), the wireless device 23 generates a routing table 105A (see FIG. 12) based on the topology information TPIF received from the wireless device 0. That is, when the transmission and reception means 102 of the wireless device 23 receives the topology information TPIF via the antenna 101, the transmission and reception means 102 stores the topology information TPIF in the information storage means 104, and also calculates an optimum route (=a route with a minimum hop number) for transmission of a packet PKT to each of the wireless devices 1 to 22 based on the topology information TPIF to generate the routing table 105A.

Similarly, when the transmission and reception means 102 of each of the wireless devices 1 to 22 receives the topology information TPIF via antenna 101, the transmission and reception means 102 stores the topology information TPIF in the information storage means 104, and also calculates an optimum route (=a route with a minimum hop number) for transmission of a packet PKT to each wireless device based on the topology information TPIF to generate a routing table.

Then, the application 106 of the wireless device 23 generates data to be transmitted to the wireless device 1, and outputs the data to the transmission and reception means 102. When the transmission and reception means 102 of the wireless device 23 receives the data from the application 106, the transmission and reception means 102 refers to the routing table 105A to detect the wireless device 18 as the “next wireless device” for transmitting a packet PKT to the destination, that is, the wireless device 1.

The transmission and reception means 102 of the wireless device 23 then stores the received data in a data portion and stores IPaddress1, the IP address of the wireless device 1 as the destination, and IPaddress18, an IP address of the wireless device 18 as the “next wireless device”, in a header to generate packet PKT=[IPaddress1/IPaddress18/data].

Thereafter, the transmission and reception means 102 of the wireless device 23 transmits the packet PKT=[IPaddress1/IPaddress18/data] to the wireless device 18 via the antenna 101.

The transmission and reception means 102 of the wireless device 18, receiving the packet PKT=[IPaddress1/IPaddress18/data] from the wireless device 23, detects IPaddress1 of the wireless device 1 (=destination) stored in the header of the packet PKT=[IPaddress1/IPaddress18/data] to recognize that the destination of the packet PKT=[IPaddress1/IPaddress18/data] is the wireless device 1.

Then, the transmission and reception means 102 of the wireless device 18 refers to a routing table in the wireless device 18 to detect the wireless device 13 as the “next wireless device” for relaying the packet PKT=[IPaddress1/IPaddress18/data] to the wireless device 1.

The transmission and reception means 102 of the wireless device 18 then replaces IPaddress18 in the packet PKT=[IPaddress1/IPaddress18/data] with IPaddress13 to generate the packet PKT=[IPaddress1/IPaddress13/data], and transmits the packet PKT=[IPaddress1/IPaddress13/data] to the wireless device 13.

Thereafter, the wireless device 6 and the wireless device 5 successively relay the packet PKT=[IPaddress1/IPaddress13/data] to the wireless device 1 by similar operations. The wireless device 1 receives the packet transmitted from the wireless device 23 and transmits a packet to the wireless device 23 via a route of the wireless device 1—the wireless device 5—the wireless device 6—the wireless device 13—the wireless device 18—the wireless device 23. With this, the wireless devices 1 and 23 perform radio communication via the route of the wireless device 1—the wireless device 5—the wireless device 6—the wireless device 13—the wireless device 18—the wireless device 23.

Each of the wireless devices 2 to 22 also performs radio communication with another wireless device by the operations as described above.

As described above, in example 1, the wireless device 0 as the root node transmits the topology information TPIF to all of the wireless devices 1 to 23 constructing the radio communication system 100, and therefore each of the wireless devices 1 to 23 can readily generate the routing table 105 formed with a route to each wireless device as a destination based on the topology information TPIF to perform radio communication with each destination.

### EXAMPLE 2

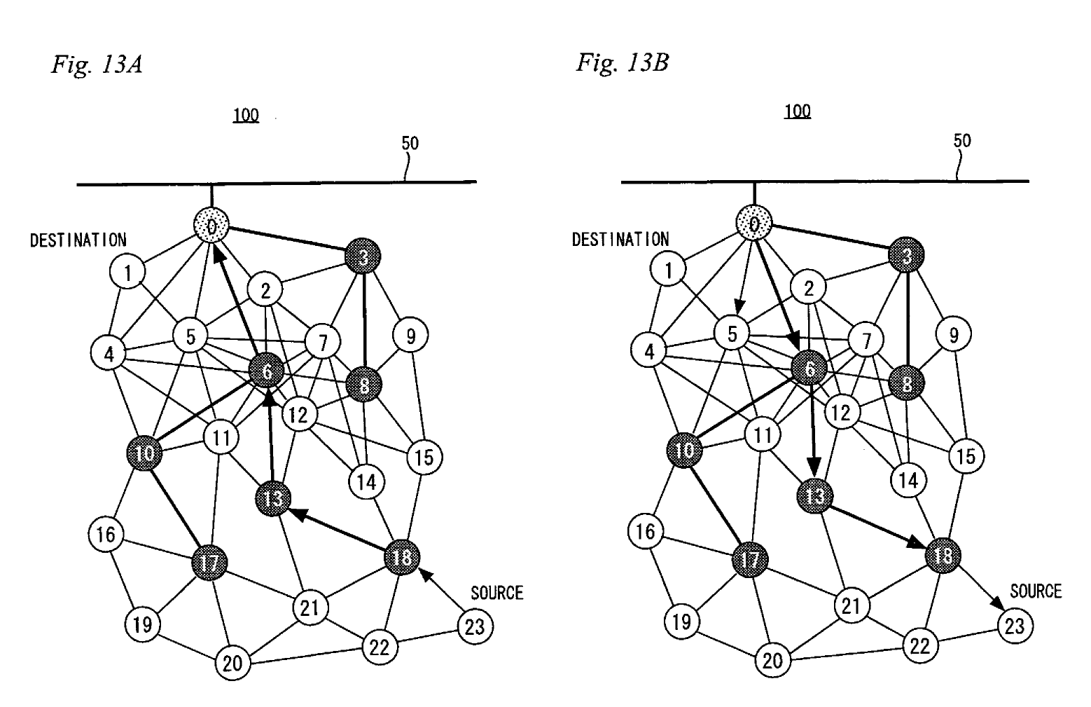

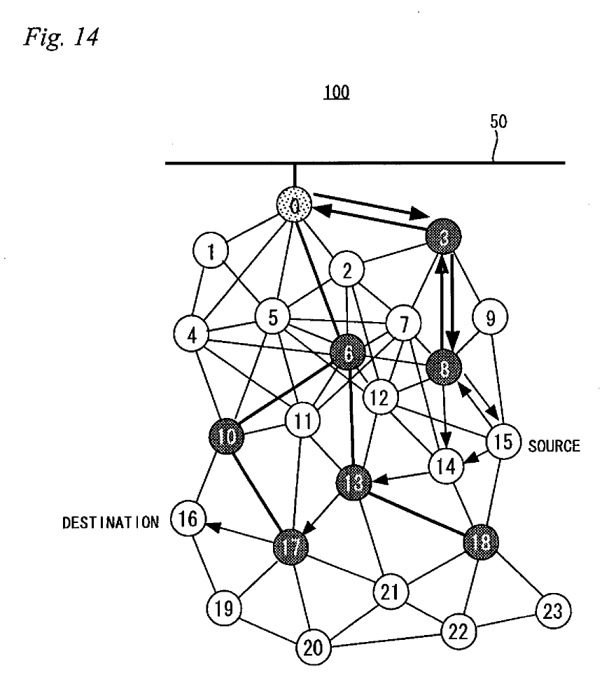

FIGS. 13A and 13B are other conceptual diagrams of a situation wherein the wireless device 0 as the root node transmits topology information.

In example 2, the wireless device 0 transmits the topology information TPIF to a wireless device (at least one of the wireless devices 1 to 23) requiring the topology information TPIF. Referring to FIGS. 13A and 13B, when the wireless device 23 (=source) starts radio communication with the wireless device 1 (=destination), the wireless device 23 has not received the topology information TPIF from the wireless device 0 and has not generated the routing table 105A setting each of the wireless devices 1 to 22 as a destination.

When the transmission and reception means 102 of the wireless device 23 receives data destined for the wireless device 1 from the application 106, the transmission and reception means 102 generates a packet PKT=[IPaddress0/IPaddress1/data] including IPaddress1 of the wireless device 1 as the destination of the data and IPaddress0 of the wireless device 0 as the root node, and transmits the packet PKT=[IPaddress0/IPaddress1/data] to the wireless device 0 via the relay route RLRT (see FIG. 13A).

The transmission and reception means 102 of the wireless device 0, when receiving the packet PKT=[IPaddress0/IPaddress1/data] from the wireless device 23 via the relay route RLRT, detects the IP address “IPaddress1” in the packet PKT=[IPaddress0/IPaddress1/data] to detect that the destination of the data is the wireless device 1.

Then, the transmission and reception means 102 of the wireless device 0 reads the topology information TPIF from the information storage means 104 and, based on the topology information TPIF, detects a route of the wireless device 23—the wireless device 18—the wireless device 13—the wireless device 6—the wireless device 5—the wireless device 1 as an optimum route for the wireless device 23 to transmit the packet PKT to the wireless device 1. The transmission and reception means 102 of the wireless device 0 then transmits the topology information TPIF to the wireless devices 5, 6, 13, 18, 23 constructing the optimum route from the wireless device 23 to the wireless device 1 (=the route of the wireless device 23—the wireless device 18—the wireless device 13—the wireless device 6—the wireless device 5—the wireless device 1) via the relay route RLRT (see FIG. 13B).

The transmission and reception means 102 of the wireless device 23 receives the topology information TPIF from the wireless device 0 via the relay route RLRT and generates the routing table 105A (see FIG. 12) setting each of the wireless devices 1 to 22 as a destination based on the topology information TPIF. Each of the wireless devices 5, 6, 13, and 18 also receives the topology information TPIF from the wireless device 0 via the relay route RLRT and generates a routing table setting each wireless device as a destination based on the topology information TPIF.

Then, the transmission and reception means 102 of the wireless device 23 refers to the routing table 105A and transmits packet PKT to the wireless device 1 (=destination) by the operations as described above. The wireless devices 18, 13, 6, and 5 receive the packet PKT from the wireless devices 23, 18, 13, and 6 and relay the packet PKT to the wireless devices 13, 6, 5, and 1, respectively, by reference to the routing tables generated. With this, the wireless device 1 receives the packet PKT transmitted from the wireless device 23. The wireless device 1 also performs radio communication with the wireless device 23 via the route of the wireless device 1—the wireless device 5—the wireless device 6—the wireless device 13—the wireless device 18—the wireless device 23.

Each of the wireless devices 2 to 22 also performs radio communication with another wireless device by the operations as described above.

It is to be noted that, when the OLSR protocol is used, the wireless device 0 as the root node may transmit the topology information TPIF to the wireless devices 13, 18, and 23 which are more than 2 hops distant from the wireless device 1 as the destination. This is because, in the OLSR protocol, the wireless devices 5 and 6 located within 2 hops from the wireless device 1 as the destination can recognize the next wireless device for relaying the packet to the wireless device 1 by transmission and reception of the Hello messages.

FIG. 14 is a diagram for describing another communication method in example 2. Referring to FIG. 14, the wireless device 15 as a source starts radio communication with the wireless device 16 as a destination by the method as described in FIGS. 13A and 13B.

After starting radio communication with the wireless device 16, the wireless device 15 as a source generates on a regular basis a message MCOM indicating the radio communication with the wireless device 16, and transmits the message to the wireless device 0 as the root node via the wireless device 8 and the wireless device 3 constructing the relay route RLRT.

The wireless device 0 as the root node receives the message MCOM via the wireless device 8 and the wireless device 3. In response to reception of the message MCOM, the wireless device 0 transmits the topology information TPIF to the wireless devices 14 and 15 via the wireless device 3 and the wireless device 8.

The wireless device 15 receives the topology information TPIF from the wireless device 0 via the wireless devices 3 and 8 and generates a routing table based on the topology information TPIF to continue radio communication with the wireless device 16. In addition, the wireless device 14 receives the topology information TPIF from the wireless device 0 via the wireless devices 3 and 8 and generates a routing table based on the topology information TPIF to continuously relay radio communication between the wireless device 15 and the wireless device 16.

As such, the wireless device 15 starting radio communication transmits the message MCOM on a regular basis to the wireless device 0 as the root node because if a valid period of the routing table is expired during the radio communication between the wireless device 15 and the wireless device 16, the wireless device 15 cannot continue the radio communication with the wireless device 16 using the generated routing table. Thus, the wireless device 15 informs the wireless device 0 as the root node of presence of an active route by the message MCOM before the expiration date of the routing table to newly receive the topology information TPIF from the wireless device 0 to newly generate the routing table to extend the valid period of the routing table.

In addition, a reason for transmission of the topology information TPIF to the wireless devices 14 and 15 by the wireless device 0 as the root node in response to reception of the message MCOM is that, though the wireless devices 13 and 17 located within 2 hops from the wireless device 16 as a destination can recognize the next wireless device for relaying the packet to the wireless device 16 by transmission and reception of the Hello messages, the wireless devices 14 and 15 which are more than 2 hops distant from the wireless device 16 as a destination cannot recognize the next wireless device for relaying the packet by transmission and reception of the Hello messages.

As described above, since the wireless device 0 as the root node transmits the topology information TPIF to the wireless device requiring the topology information TPIF in example 2, overhead of the radio communication system 100 can be reduced.

### EXAMPLE 3

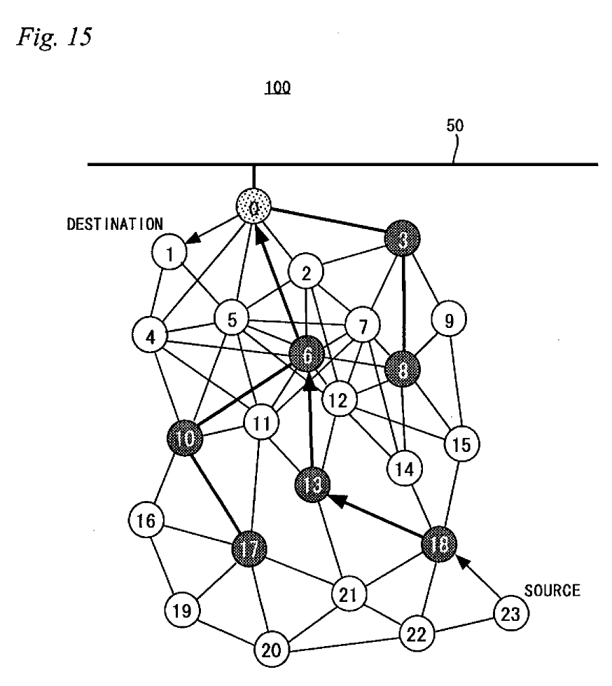

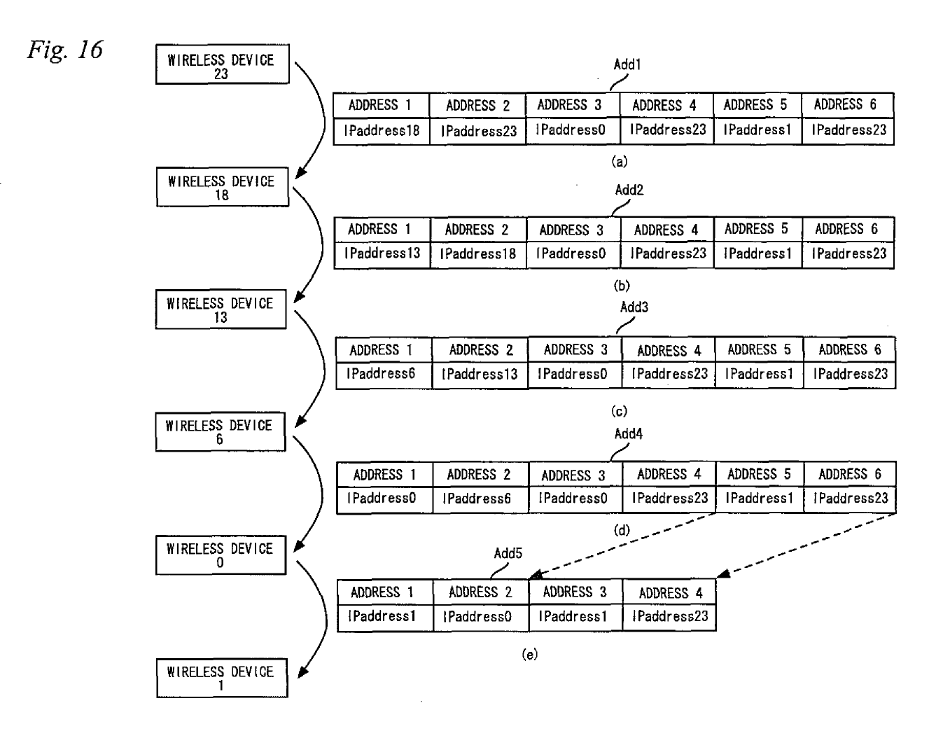

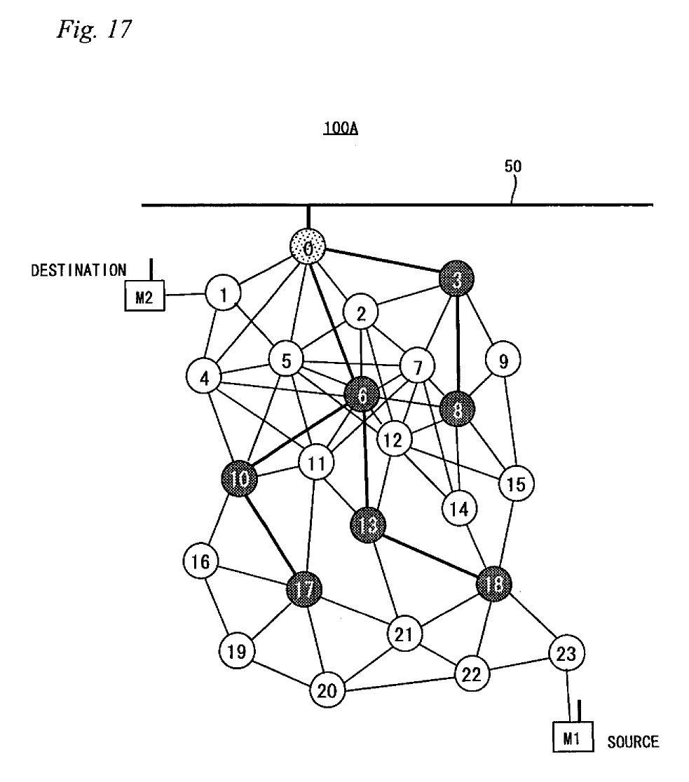

FIG. 15 is a diagram for describing a communication method in example 3. FIG. 16 shows address solutions in example 3. Referring to FIG. 15, in example 3, the wireless device 0 as the root node does not transmit the topology information TPIF to the wireless devices 1 to 23, and the wireless device 23 as a source transmits a packet PKT to the wireless device 1 as a destination via the wireless device 0 as the root node.

In this situation, the wireless device 23 transmits the packet PKT to the wireless device 1 using a Six Address Solution.

Referring to FIG. 16, the transmission and reception means 102 of the wireless device 23 receives data from the application 106 and generates a packet PKT [Add1/data] including an address Add1 in a header. Address Add1 is formed with addresses 1 to 6. Address 1 is formed with an IP address of a wireless device which receives the packet in radio communication between two wireless devices, and address 2 is formed with an IP address of a wireless device which transmits the packet in radio communication between two wireless devices. In addition, address 3 is formed with an IP address of the wireless device 0 as the root node, and address 4 is formed with an IP address of a source when the packet is transmitted to the wireless device 0 as the root node. Furthermore, address 5 is formed with an IP address of a destination, and address 6 is formed with an IP address of the source.

For transmission of a packet PKT to the wireless device 1 as the destination, the transmission and reception means 102 of the wireless device 23 transmits the packet PKT to the wireless device 0 (=root node) via the relay route RLRT because the transmission and reception means 102 of the wireless device 23 does not know a route to wireless device 1. Therefore, the transmission and reception means 102 of the wireless device 23 generates address Add1 (see (a) of FIG. 16) to transmit the packet PKT to the wireless device 18 which is nearest from the wireless device 23 among the wireless devices 3, 6, 8, 10, 13, 17, and 18 constructing the relay route RLRT. In this situation, address 1 is formed with IPaddress18, the IP address of the wireless device 18 receiving the packet PKT in radio communication between the wireless device 23—the wireless device 18, and address 2 is formed with IPaddress23, the IP address of the wireless device 23 transmitting packet PKT in radio communication between the wireless device 23—the wireless device 18. In addition, address 3 is formed with IPaddress0, the IP address of the wireless device 0 as the root node, and address 4 is formed with IPaddress23, the IP address of the wireless device 23 as the source in radio communication to the wireless device 0. Furthermore, address 5 is formed with IPaddress1, the IP address of the wireless device 1 as the destination, and address 6 is formed with IPaddress23, the IP address of the wireless device 23 as the source.

After generation of the address Add1, the transmission and reception means 102 of the wireless device 23 generates a packet PKT=[Add1/data] including the address Add1 in a header and transmits the packet PKT to the wireless device 18.

The transmission and reception means 102 of the wireless device 18 receives packet PKT=[Add1/data] from the wireless device 23 and, referring to the address Add1 in the packet PKT [Add1/data], detects that the packet PKT [Add1/data] is to be transmitted to the wireless device 0 as the root node. Since the wireless device 13 is the next wireless device for the wireless device 18 to relay the packet PKT to the wireless device 0, the transmission and reception means 102 of the wireless device 18 then changes address 1 from IPaddress18 to IPaddress13 and changes address 2 from IPaddress23 to IPaddress18 to generate an address Add2 (see (b) of FIG. 16), and generates a packet PKT=[Add2/data] including the address Add2 in a header. Thereafter, the transmission and reception means 102 of the wireless device 18 transmits the packet PKT=[Add2/data] to the wireless device 13.

The transmission and reception means 102 of the wireless device 13 receives the packet PKT=[Add2/data] from the wireless device 18 and generates an address Add3 (see (c) of FIG. 16) by the method as described above. Then, the transmission and reception means 102 of the wireless device 13 generates a packet PKT=[Add3/data] including the address Add3 in a header and transmits the packet PKT to the wireless device 6.

The transmission and reception means 102 of the wireless device 6 receives the packet PKT=[Add3/data] from the wireless device 13 and generates an address Add4 (see (d) of FIG. 16) by the method as described above. Then, the transmission and reception means 102 of the wireless device 6 generates a packet PKT=[Add4/data] including the address Add4 in a header and transmits the packet PKT to the wireless device 0.

The transmission and reception means 102 of the wireless device 0 as the root node receives the packet PKT=[Add4/data] from the wireless device 6 and, referring to the address Add4 in the packet PKT=[Add4/data], detects the wireless device 1 as the destination of the packet PKT=[Add4/data]. Then, the transmission and reception means 102 of the wireless device 0 reads the topology information TPIF (see FIG. 9) from the information storage means 104 and refers to the topology information TPIF to detect that the wireless device 1 is neighboring to the wireless device 0.

Then, the transmission and reception means 102 of the wireless device 0 changes the address 1 from IPaddress0 to IPaddress1, changes the address 2 from IPaddress6 to IPaddress0, and stores the addresses 5 and 6 of the address Add4 in the addresses 3 and 4, respectively, to generate an address Add5 (see (e) of FIG. 16). That is, the transmission and reception means 102 of the wireless device 0 changes the address from the Six Address Solution to a Four Address Solution to generate the address Add5. Thereafter, the transmission and reception means 102 of the wireless device 0 generates a packet PKT=[Add5/data] including the address Add5 in a header and transmits the packet PKT to the wireless device 1.

The transmission and reception means 102 of the wireless device 1 receives the packet PKT=[Add5/data] from the wireless device 0 and, referring to the address Add5 in the packet PKT=[Add5/data], detects that the packet PKT=[Add5/data] is destined for the wireless device 1. Then, the transmission and reception means 102 of the wireless device 1 extracts data from the packet PKT=[Add5/data] to output the data to the application 106, and the application 106 receives the data. As a result, radio communication from the wireless device 23 to the wireless device 1 is completed.

When a packet PKT is transmitted from the wireless device 1 to the wireless device 23, the transmission and reception means 102 of the wireless device 1 transmits the packet PKT to the wireless device 23 via the wireless device 0 by the method as described above.

Each of the wireless devices 1 to 22 also transmits a packet PKT to a destination via the wireless device 0 as the root node by the method as described above.

As described above, each of the wireless devices 1 to 23 in example 3 transmits a packet PKT to a destination via the wireless device 0 storing the topology information TPIF, the Six Address Solution is used in radio communication from a source wireless device to the wireless device 0 as the root node and the Four Address Solution is used in radio communication from the wireless device 0 as the root node to a destination wireless device. The topology information TPIF is not transmitted from the wireless device 0 to each of the wireless devices 1 to 23. Therefore, overhead in the radio communication system 100 can be reduced.

### EXAMPLE 4

In example 4, mobile terminals each performing radio communication via each of the wireless devices 1 to 23 as an access point are added as terminals constructing a radio communication system. FIG. 17 is a schematic diagram of another radio communication system according to an embodiment of the present invention. The radio communication system according to an embodiment of the present invention may be a radio communication system 100A shown in FIG. 17. Referring to FIG. 17, the radio communication system 100A is similar to the radio communication system 100 shown in FIG. 1 except for mobile terminals M1 and M2 added to the radio communication system 100.

The mobile terminal M1 performs radio communication via the wireless device 23, while the mobile terminal M2 performs radio communication via the wireless device 1. Therefore, the wireless device 23 transmits a terminal message AS 1 indicating presence of the mobile terminal M1 having access thereto to the wireless device 0 via the relay route RLRT by unicast, and the wireless device 1 transmits a terminal message AS2 indicating presence of the mobile terminal M2 having access thereto to the wireless device 0 by unicast.

Then, the transmission and reception means 102 of the wireless device 0 receives the terminal messages AS1 and AS2 and updates the topology information TPIF based on the terminal messages AS1 and AS2. The transmission and reception means 102 of the wireless device 0 then stores updated topology information TPIF in the information storage means 104.

As described above, in the radio communication system 100A, the wireless device 0 as the root node generates and stores the topology information TPIF including information of the mobile terminals M1 and M2 and the wireless devices 0 to 23.

Situations will now be described wherein the mobile terminal M1 transmits a packet PKT to the mobile terminal M2.

(a) Transmission Not Via the Wireless Device 0 as the Root Node

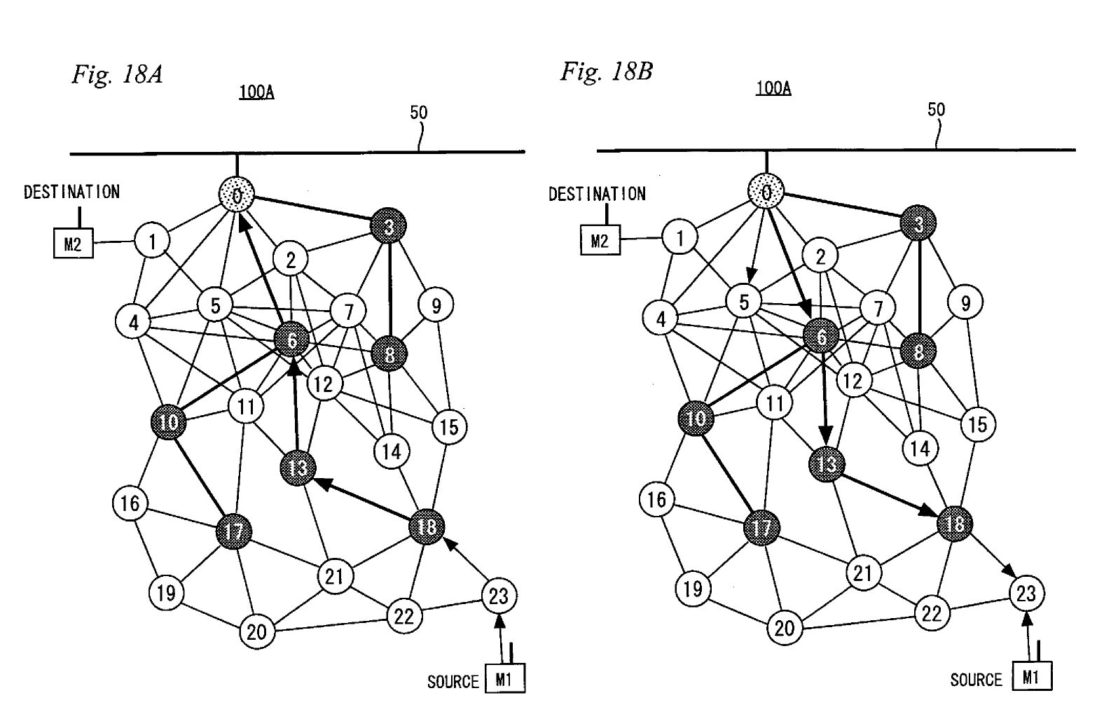

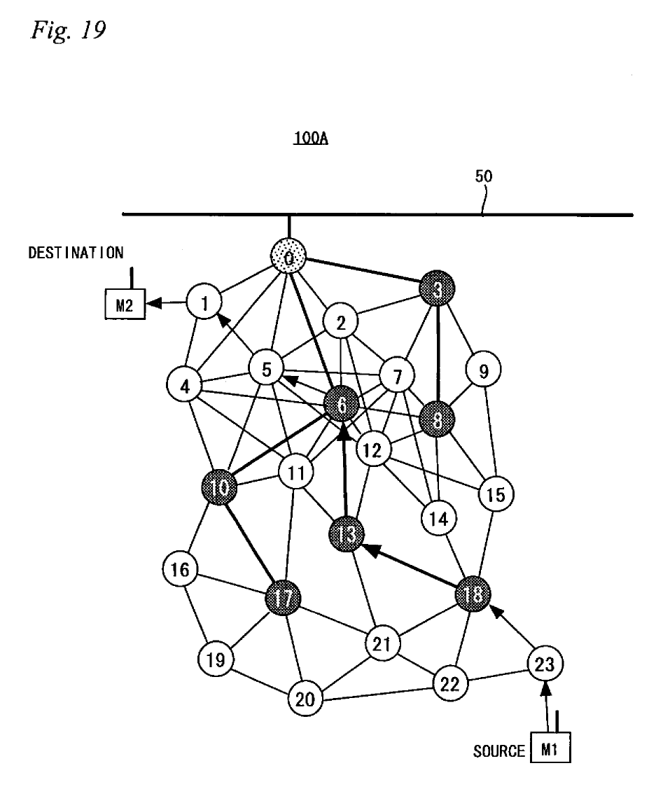

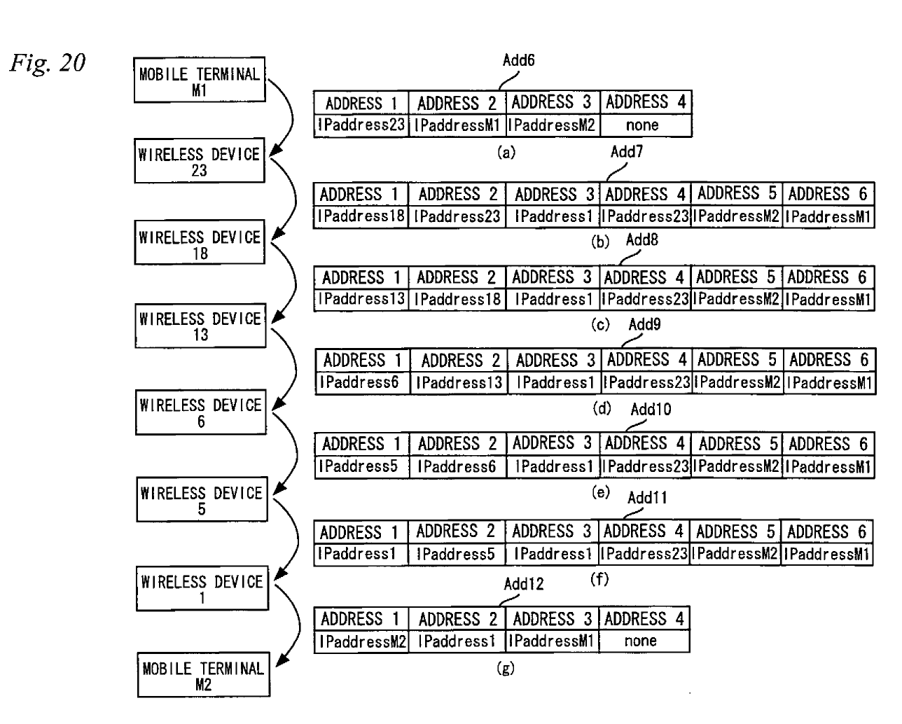

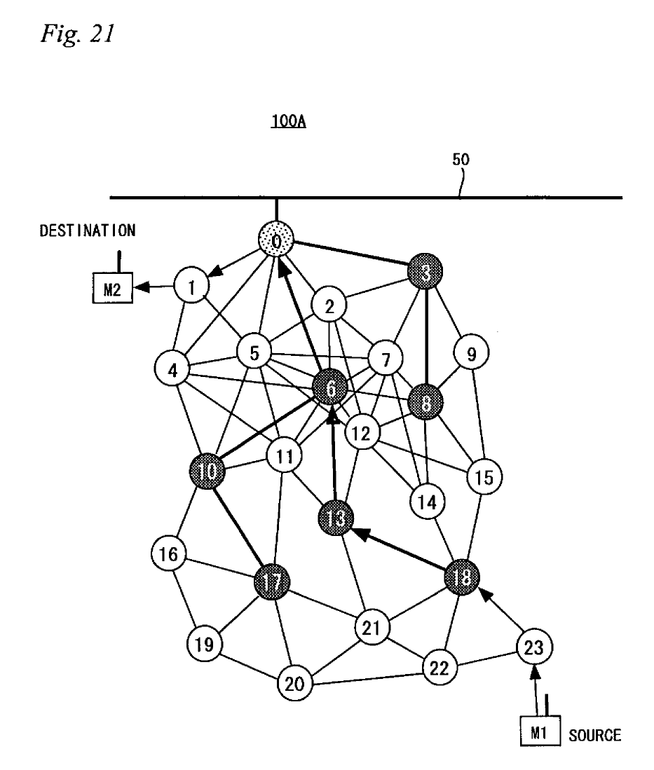

FIGS. 18A and 18B are still other conceptual diagrams of a situation wherein the wireless device 0 as the root node transmits topology information. FIG. 19 is a diagram for describing a communication method in example 4. FIG. 20 shows address solutions in example 4.

Referring to FIGS. 18A and 18B, when the mobile terminal M1 needs to transmit a packet PKT to the mobile terminal M2, the mobile terminal M1 generates an address Add6 (see (a) of FIG. 20) with the Four Address Solution, and generates a packet PKT=[Add6/data] including the address Add6 in a header to transmit the packet PKT to the wireless device 23. In this situation, address 1 is formed with IPaddress23, the IP address of the wireless device 23 receiving the packet PKT in radio communication between the mobile terminal M1—the wireless device 23, address 2 is formed with IPaddressM1, an IP address of the mobile terminal M1 transmitting the packet PKT in radio communication between the mobile terminal M1—the wireless device 23, and address 3 is formed with IPaddressM2, an IP address of the mobile terminal M2 as the destination.

The transmission and reception means 102 of the wireless device 23 receives the packet PKT=[Add6/data] from the mobile terminal M1 and, referring to the address Add6 in the packet PKT=[Add6/data], detects that the packet PKT [Add6/data] is destined for the mobile terminal M2.

The transmission and reception means 102 of the wireless device 23, however, does not know the wireless device accessed by the mobile terminal M2 (an access point), and therefore transmits a transmission request for the topology information TPIF to the wireless device 0 as the root node to determine the wireless device accessed by the mobile terminal M2 for transmission of the packet PKT=[Add6/data] to the mobile terminal M2 (see FIG. 18A). The transmission and reception means 102 of each of the wireless devices 5, 6, 13, 18, and 23 then receives the topology information TPIF from the wireless device 0 (see FIG. 18B). Operations of the transmission and reception means 102 of the wireless device 23 for transmitting the transmission request for the topology information TPIF to the wireless device 0 and operations of the wireless devices 5, 6, 13, 18, and 23 for receiving the topology information TPIF from the wireless device 0 are similar to those described in FIGS. 13A and 13B.

The transmission and reception means 102 of the wireless device 23 receives the topology information TPIF and, based on the topology information TPIF, detects that the mobile terminal M2 has access to the wireless device 1.

Then, the transmission and reception means 102 of the wireless device 23 relays the packet PKT=[Add6/data] received from the mobile terminal M1 to the wireless device 1. That is, the transmission and reception means 102 of the wireless device 23 generates an address Add7 (see (b) of FIG. 20) with the Six Address Solution, and generates a packet PKT=[Add7/data] including the address Add7 in a header to transmit the packet PKT to the wireless device 18. In this situation, address 3 of the address Add7 is formed with the IP address (=IPaddress1) of the destination in the network formed with the wireless devices 0 to 23 as access points, and address 4 of the address Add7 is formed with the IP address (=IPaddress23) of the source in the network formed with the wireless devices 0 to 23 as access points. Address 1, address 2, address 5, and address 6 are as described above.

The transmission and reception means 102 of the wireless device 18 receives the packet PKT=[Add7/data] from the wireless device 23 and generates an address Add8 (see (c) of FIG. 20) by the method as described above. Then, the transmission and reception means 102 of the wireless device 18 generates a packet PKT=[Add8/data] including the address Add8 in a header and transmits the packet PKT to the wireless device 13.

Successively, the transmission and reception means 102 of the wireless device 13 receives the packet PKT=[Add8/data] from the wireless device 18 and generates an address Add9 (see (d) of FIG. 20) by the method as described above. Then, the transmission and reception means 102 of the wireless device 13 generates a packet PKT=[Add9/data] including the address Add9 in a header and transmits the packet PKT to the wireless device 6.

Thereafter, the transmission and reception means 102 of the wireless device 6 receives the packet PKT=[Add9/data] from the wireless device 13 and generates an address Add10 (see (e) of FIG. 20) by the method as described above. Then, the transmission and reception means 102 of the wireless device 6 generates a packet PKT=[Add10/data] including the address Add10 in a header and transmits the packet PKT to the wireless device 5.

Successively, the transmission and reception means 102 of the wireless device 5 receives the packet PKT=[Add10/data] from the wireless device 6 and generates an address Add11 (see (f) of FIG. 20) by the method as described above. Then, the transmission and reception means 102 of the wireless device 5 generates a packet PKT=[Add11/data] including the address Add11 in a header and transmits the packet PKT to the wireless device 1.

The transmission and reception means 102 of the wireless device 1 receives the packet PKT=[Add11/data] from the wireless device 5 and, referring to the address Add11 in the packet PKT=[Add11/data], detects that the packet PKT [Add11/data] is destined for the mobile terminal M2. Then, the transmission and reception means 102 of the wireless device 1 generates an address Add12 (see (g) of FIG. 20) with the Four Address Solution, and generates a packet PKT=[Add12/data] including the address Add12 in a header to transmit the packet PKT to the mobile terminal M2.

The mobile terminal M2 receives the packet PKT=[Add12/data] from the wireless device 1 and, referring to the address Add12 in the packet PKT=[Add12/data], detects that the packet PKT=[Add12/data] is destined for the mobile terminal M2.

As described above, the Four Address Solution is used in radio communication between the mobile terminal M1 and the wireless device 23 and that between the mobile terminal M2 and the wireless device 1 (see (a) and (g) of FIG. 20), while the Six Address Solution is used in radio communication in the network formed with the wireless devices 0 to 23 (see (b) to (f) of FIG. 20).

In addition, each of the wireless devices 23, 18, 13, 6, and 5 relays packet PKT with designation of the wireless device 1 accessed by the mobile terminal M2 (see address 3 of each of (b) to (f) of FIG. 20), not with designation of the mobile terminal M2 as the destination. As a result, it is not necessary for each of the wireless devices 5, 6, 13, 18, and 23 to know the IP address of the mobile terminal M2, and only a change of the next wireless device for relaying is required. Therefore, overhead of the radio communication system 100A can be reduced.

In addition, since the wireless device 0 as the root node transmits the topology information TPIF to the wireless devices 5, 6, 13, 18, and 23 requiring the topology information TPIF, overhead of the radio communication system 100A can be reduced.

It is to be noted that the wireless device 0 as the root node may transmit the topology information TPIF to all of the wireless devices 1 to 23 on a regular basis.

(b) Transmission Via the Wireless Device 0 as the Root Node

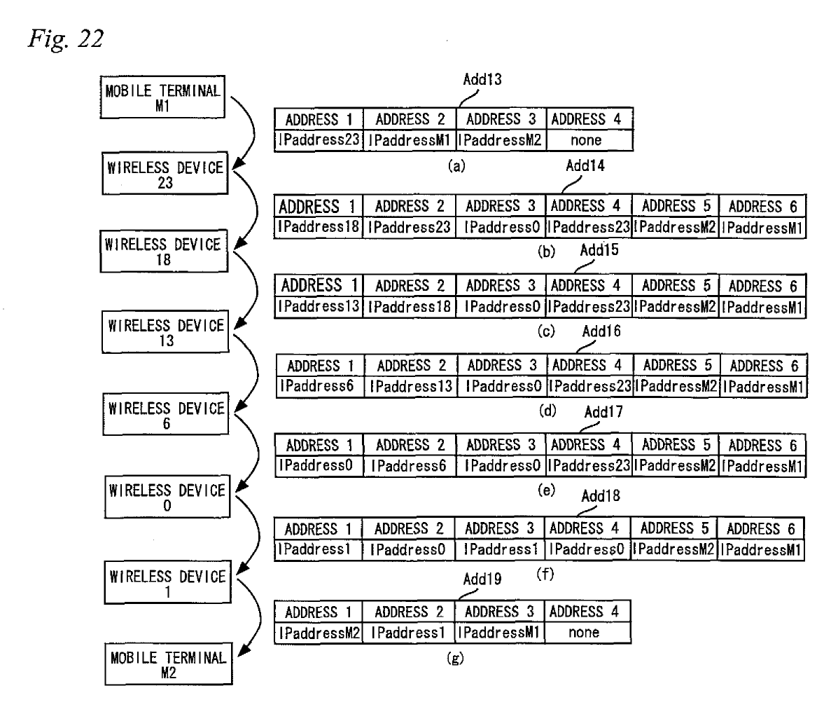

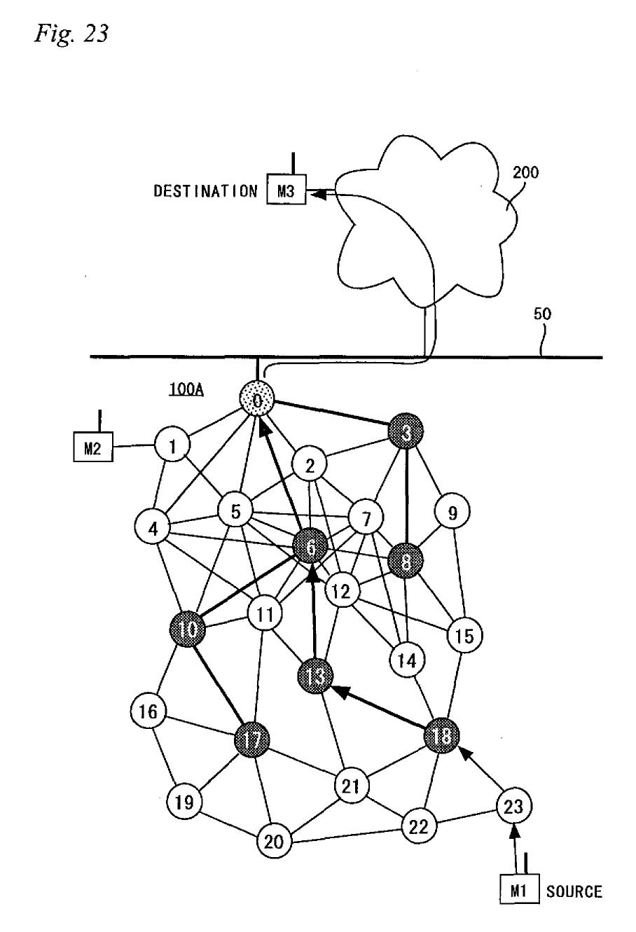

FIG. 21 is another diagram for describing a communication method in example 4. FIG. 22 is another diagram of the address solutions in example 4.

Referring to FIG. 21, when the mobile terminal M1 needs to transmit a packet PKT to the mobile terminal M2, the mobile terminal M1 generates an address Add13 (see (a) of FIG. 22) with the Four Address Solution, and generates a packet PKT=[Add13/data] including the address Add13 in a header to transmit the packet PKT to the wireless device 23.

The transmission and reception means 102 of the wireless device 23 receives the packet PKT=[Add13/data] from the mobile terminal M1 and, referring to the address Add13 in the packet PKT=[Add13/data], detects that the packet PKT=[Add13/data] is destined for the mobile terminal M2. Not knowing the wireless device accessed by the mobile terminal M2, the transmission and reception means 102 of the wireless device 23 transmits the packet PKT to the wireless device 0 (=root node) via the relay route RLRT. Therefore, the transmission and reception means 102 of the wireless device 23 generates an address Add14 (see (b) of FIG. 22) with the Six Address Solution in order to transmit the packet PKT to the wireless device 18 which is nearest from the wireless device 23 among the wireless devices 3, 6, 8, 10, 13, 17, and 18 constructing the relay route RLRT. The method for generation of the address Add14 with the Six Address Solution is as described above.

After generation of the address Add14, the transmission and reception means 102 of the wireless device 23 generates a packet PKT=[Add14/data] including the address Add14 in a header and transmits the packet PKT to the wireless device 18.

The transmission and reception means 102 of the wireless device 18 receives the packet PKT=[Add14/data] from the wireless device 23 and, referring to the address Add14 in the packet PKT=[Add14/data], detects that the packet PKT=[Add14/data] is to be transmitted to the wireless device 0 as the root node. Since the wireless device 13 is the next wireless device for the wireless device 18 to relay the packet PKT to the wireless device 0, the transmission and reception means 102 of the wireless device 18 then changes address 1 from IPaddress18 to IPaddress13 and changes address 2 from IPaddress23 to IPaddress18 to generate an address Add15 (see (c) of FIG. 22), and generates a packet PKT=[Add15/data] including the address Add15 in a header. Thereafter, the transmission and reception means 102 of the wireless device 18 transmits the packet PKT=[Add15/data] to the wireless device 13.

The transmission and reception means 102 of the wireless device 13 receives the packet PKT=[Add15/data] from the wireless device 18 and generates an address Add16 (see (d) of FIG. 22) by the method as described above. Then, the transmission and reception means 102 of the wireless device 13 generates a packet PKT=[Add16/data] including the address Add16 in a header and transmits the packet PKT to the wireless device 6.

The transmission and reception means 102 of the wireless device 6 receives the packet PKT [Add16/data] from the wireless device 13 and generates an address Add17 (see (e) of FIG. 22) by the method as described above. Then, the transmission and reception means 102 of the wireless device 6 generates a packet PKT=[Add17/data] including the address Add17 in a header and transmits the packet PKT to the wireless device 0.

The transmission and reception means 102 of the wireless device 0 as the root node receives the packet PKT=[Add17/data] from the wireless device 6 and, referring to the address Add17 in the packet PKT=[Add17/data], detects the wireless device 1 as the destination of the packet PKT=[Add17/data]. Then, the transmission and reception means 102 of the wireless device 0 reads the topology information TPIF (see FIG. 9) from the information storage means 104 and refers to the topology information TPIF to detect that the wireless device 1 is neighboring to the wireless device 0.

Then, the transmission and reception means 102 of the wireless device 0 changes address 1 from IPaddress0 to IPaddress1, address 2 from IPaddress6 to IPaddress0, and address 4 from IPaddress23 to IPaddress0, the IP address of the wireless device 0, to generate an address Add18 (see (f) of FIG. 22). Thereafter, the transmission and reception means 102 of the wireless device 0 generates a packet PKT=[Add18/data] including the address Add18 in a header and transmits the packet PKT to the wireless device 1.

The transmission and reception means 102 of the wireless device 1 receives the packet PKT=[Add18/data] from the wireless device 0 and, referring to the address Add18 in the packet PKT=[Add18/data], detects that the packet PKT=[Add18/data] is destined for the mobile terminal M2. Then, the transmission and reception means 102 of the wireless device 1 generates an address Add19 (see (g) of FIG. 22) with the Four Address Solution, and generates a packet PKT=[Add19/data] including the address Add19 in a header to transmit the packet PKT to the mobile terminal M2.

The mobile terminal M2 receives the packet PKT=[Add19/data] from the wireless device 1 and, referring to the address Add19 in the packet PKT=[Add19/data], detects that the packet PKT=[Add19/data] is destined for the mobile terminal M2. As a result, radio communication from the mobile terminal M1 to the mobile terminal M2 is completed.

As described above, the Four Address Solution is used in radio communication between the mobile terminal M1 and the wireless device 23 and that between the mobile terminal M2 and the wireless device 1 (see (a) and (g) of FIG. 22), while the Six Address Solution is used in radio communication in the network formed with the wireless devices 0 to 23 (see (b) to (f) of FIG. 22).

In addition, radio communication from the wireless device 23 to the wireless device 0 is performed with the wireless device 23 set as the source and the wireless device 0 set as the destination (see addresses 3 and 4 of (b) to (e) of FIG. 22), and radio communication from the wireless device 0 to the wireless device 1 is performed with the wireless device 1 set as the destination and the wireless device 0 set as the source (see addresses 3 and 4 of (f) of FIG. 22). As a result, it is not necessary for each of the wireless devices 6, 13, 18, and 23 to know the IP address of the mobile terminal M2, and only a change of the next wireless device for relaying is required. Therefore, overhead of the radio communication system 100A can be reduced.

In addition, since the wireless device 0 as the root node does not transmit the topology information TPIF, overhead of the radio communication system 100A can be reduced.

(c) Transmission to a Mobile Terminal Belonging to Another Radio Communication System

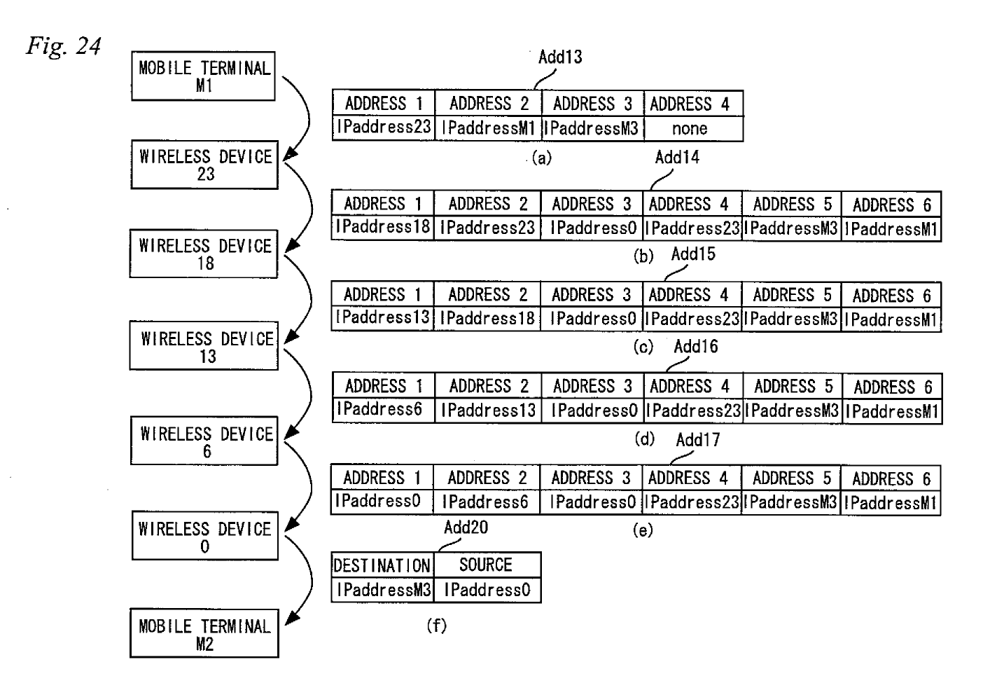

FIG. 23 is a diagram for describing a method for transmitting a packet to a mobile terminal belonging to another radio communication system. FIG. 24 is still another diagram of the address solutions in example 4.

Referring to FIG. 23, a mobile terminal M3 is connected to a radio communication system 200 which is different from the radio communication system 100A. The radio communication system 200 is connected to the wired cable 50.

When the mobile terminal M1 transmits a packet PKT to the mobile terminal M3 belonging to the radio communication system 200, the wireless devices 23, 18, 13, and 6 relay the packet PKT to the wireless device 0 as the root node, and the wireless device 0 transmits the packet PKT to the radio communication system 200 via the wired cable 50.

More specifically, the mobile terminal M1 transmits a packet PKT including the aforementioned address Add13 (see (a) of FIG. 24) to the wireless device 23, and the wireless devices 23, 18, 13, and 6 respectively relay packets PKTs including the aforementioned addresses Add14 to Add17 (see (b) to (e) of FIG. 24) to the wireless device 0.

The transmission and reception means 102 of the wireless device 0 receives the packet PKT including the address Add17 and, referring to the address Add17 in the packet PKT=[Add17/data], detects that the packet PKT=[Add17/data] is destined for the mobile terminal M3. Then, the transmission and reception means 102 of the wireless device 0 reads the topology information TPIF from the information storage means 104 and, referring to the topology information TPIF, detects that the mobile terminal M3 is not present in the radio communication system 10A.

Then, the transmission and reception means 102 of the wireless device 0 generates an address Add20 including IPaddressM3 as an IP address of the destination and IPaddress0 of the wireless device 0 as the source, and generates a packet PKT=[Add20/data] including the address Add20 in a header. Thereafter, the transmission and reception means 102 of the wireless device 0 transmits the packet PKT=[Add20/data] to the radio communication system 200 via the wired cable 50. The radio communication system 200 transmits the packet PKT=[Add20/data] to the mobile terminal M3, and the mobile terminal M3 receives the packet PKT=[Add20/data] from the radio communication system 200. With this, operations for transmission of the packet PKT from the mobile terminal M1 to the mobile terminal M3 belonging to another radio communication system 200 are completed.

As described above, when the mobile terminal M1 belonging to the radio communication system 100A transmits the packet PKT to the mobile terminal M3 belonging to another radio communication system 200, the packet PKT is transmitted via the wireless device 0 storing the topology information TPIF. Therefore, transmission of the topology information TPIF by the wireless device 0 is not required, and thus overhead of the radio communication system 100A can be reduced.

It is to be noted that, though the radio communication system 100A described above includes the mobile terminals M1, M2 having access to the wireless devices 23 and 1, respectively, the radio communication system 100A may include a mobile terminal having access to any of the other wireless devices 0, and 2 to 22.

The Six Address Solution is used in example 3 and example 4 described above. When the Six Address Solution is used in example 3, radio communication is performed via the wireless device 0 storing the topology information TPIF. In this situation, a source wireless device should only transmit packet PKT with designation of the wireless device 0 without knowing a route to a destination wireless device (see (a) to (d) of FIG. 16). That is, it is not necessary for the source wireless device to search for a route to the destination wireless device. It is also not necessary for the wireless device 0 to transmit the topology information TPIF to the wireless devices 1 to 23. Therefore, overhead in the radio communication system 100 can be reduced.

In addition, when the Six Address Solution is used in example 4, the wireless device 23 receiving packet PKT from the mobile terminal M1 can recognize wireless device 1 accessed by the mobile terminal M2 as the destination by teaching of the wireless device 0, that is, searching is not required (recognition of the wireless device 1 accessed by the mobile terminal M2 based on the topology information TPIF received from the wireless device 0 corresponds to reception of teaching of the wireless device 0 as to the wireless device accessed by the mobile terminal M2). Therefore, overhead of radio communication system 100A can be reduced.

Furthermore, when the Six Address Solution is used in example 4, the wireless device 23 receiving packet PKT from the mobile terminal M1 is not required to search whether the mobile terminal M3 as the destination belongs to the radio communication system 100A or to another radio communication system 200, and the wireless device 0 does not transmit the topology information TPIF to the wireless devices 1 to 23. Therefore, overhead of the radio communication system 100A can be reduced.

As described above, overhead of the radio communication systems 100 and 100A can be reduced when radio communication is performed using the Six Address Solution in the radio communication systems 100 and 100A according to the present invention.

It is to be noted that, in the present invention, the wireless device 0 constructs a “first wireless device”, the wireless devices 3, 6, 8, 10, 13, 17, and 18 construct a “plurality of second wireless devices”, and the wireless devices 1, 2, 4, 5, 7, 9, 11, 12, 14, 15, 16, and 19 to 23 construct a “plurality of third wireless devices”.

In addition, route RT constructs a “relay route” and the mobile terminals M1 and M2 construct a “plurality of wireless devices”.

The embodiments disclosed herein are by way of illustration in all points and should not be taken by way of limitation. The scope of the present invention is indicated not by the above-described embodiments but by the appended claims, and it is intended to encompass all modifications falling within the equivalent meaning and scope of the appended claims.

What is claimed is:

1. A radio communication system enabling reduction in overhead of a control packet, comprising:
a first wireless device connected to a wired cable;
a plurality of second wireless devices arranged under said first wireless device and constructing a relay route for relaying a packet transmitted from said first wireless device such that, when said first wireless device transmits the packet to all wireless devices constructing said radio communication system, each of said all wireless devices transmits and receives the packet once; and
a plurality of third wireless devices arranged under said first wireless device and transmitting a packet to said first wireless device via any of said plurality of second wireless devices.

2. The radio communication system according to claim 1, wherein
each of said plurality of second wireless devices transmits first neighboring wireless device information, information of neighboring wireless device thereof, to said first wireless device via said relay route,
each of said plurality of third wireless devices transmits second neighboring wireless device information, information of neighboring wireless device thereof, to said first wireless device via any of said plurality of second wireless devices, and
said first wireless device obtains said first and second neighboring wireless device information via said relay route and, based on said first and second neighboring wireless device information obtained, acquires topology information, information of a topology of all wireless devices constructing said radio communication system.

3. The radio communication system according to claim 2, wherein
said first wireless device transmits said topology information to said all wireless devices via said relay route on a regular basis,
each of said plurality of second wireless devices receives said topology information via said relay route and, using said topology information received, performs radio communication with a destination wireless device, and
each of said plurality of third wireless devices receives said topology information via one of said plurality of second wireless devices nearest therefrom and, using said topology information received, performs radio communication with a destination wireless device.

4. The radio communication system according to claim 2, wherein
said first wireless device transmits said topology information via said relay route when the wireless device thereunder needs said topology information.

5. The radio communication system according to claim 4, wherein
when a destination wireless device is unknown, a source wireless device included in said plurality of second wireless devices or said plurality of third wireless devices transmits a packet to be transmitted to said first wireless device via said relay route, receives said topology information from said first wireless device via said relay route, searches for an optimum route to the destination wireless device based on said topology information received, and then transmits said packet to said destination wireless device along said optimum route found.

6. The radio communication system according to claim 5, further comprising
a plurality of wireless devices arranged under said second wireless devices or said third wireless devices; wherein
a source wireless device included in said plurality of wireless devices generates a packet including a destination wireless device and transmits said packet to said second wireless device or said third wireless device to be accessed,
said second wireless device or said third wireless device receiving said packet from said source wireless device transmits said packet to said second wireless device or said third wireless device having said destination wireless device thereunder, and
said second wireless device or said third wireless device having said destination wireless device thereunder receives said packet and transmits said packet to said destination wireless device.

7. The radio communication system according to claim 6, wherein
each of said plurality of second wireless devices and said plurality of third wireless devices is an access point.

8. The radio communication system according to claim 4, wherein
when a destination wireless device is unknown, a source wireless device included in said plurality of second wireless devices or said plurality of third wireless devices transmits a packet to be transmitted to said first wireless device via said relay route, and
said first wireless device searches for an optimum route to said destination wireless device based on a destination included in the packet transmitted from said source wireless device and said topology information, and transmits said packet to said destination wireless device along said optimum route found.

9. The radio communication system according to claim 4, wherein
said first wireless device transmits said topology information via said relay route when receiving a message indicating presence of an active route from the wireless device thereunder.
